(19) United States
(12) Patent Application Publication
(10) Pub. No.: US 2025/0374035 A1
(43) Pub. Date: Dec. 4, 2025

(54) CAPABILITY REPORTING METHOD, CAPABILITY DETERMINATION METHOD, COMMUNICATION APPARATUS, AND STORAGE MEDIUM

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 18/872,735

(22) PCT Filed: Jun. 6, 2022
(86) PCT No.: PCT/CN2022/097231

§ 371 Date: Dec. 6, 2024

(51) Int. Cl. H04W 8/24; H04W 28/02; H04W 64/00

(52) U.S. Cl. CPC H04W 8/24; H04W 28/0278; H04W 64/006

(57) ABSTRACT

A method and system for capability reporting and determination, designed to optimize data buffering in communication networks, particularly in environments with potential communication disruptions. A terminal reports its capability to buffer data in advance to a network device. Upon determining that the terminal is capable, the network device configures the terminal to send request information, which may include auxiliary details such as data volume, timing, or duration. Conditions for sending requests are specified, including location, signal strength, and speed thresholds. The system supports high-speed-railway dedicated networks and tunnels as examples of affected regions. Communication apparatuses and non-transitory computer-readable storage media are provided, enabling terminals and network devices to execute the described methods. Configurations may include blocking timers and other conditions for optimizing communication efficiency. This invention enhances data management and communication reliability in constrained network environments.

### CROSS-REFERENCE TO RELATED APPLICATIONS

The present disclosure is a U.S. national phase of PCT Application No. PCT/CN2022/097231 filed on Jun. 6, 2022, the content of which is hereby incorporated by reference in its entirety.

### TECHNICAL FIELD

The present disclosure relates to a field of communication technologies, and in particular to a capability reporting method, a capability determination method, communication apparatuses, and computer-readable storage mediums.

### BACKGROUND

With the rapid development of high-speed-railway technologies and rapid deployment and opening of high-speed-railways, more and more users will select high-speed-trains to travel. To meet communication requirements of mobile users riding the high-speed-trains and ensure communication qualities of the mobile users, an operator selects to deploy a high-speed-railway dedicated network to specifically serve the mobile users.

There is a great difference between the high-speed-railway dedicated network and a common public long term evolution (LTE) network. In the high-speed-railway dedicated network, a plurality of RRUs (remote radio units) are cascaded together as a cell, to serve mobile users on the high-speed-trains.

### SUMMARY

Embodiments of the present disclosure provide a capability reporting method, a capability determination method, communication apparatuses, and computer-readable storage mediums.

According to a first aspect of the embodiments of the present disclosure, a capability reporting method is provided. The method is performed by a terminal and includes: sending capability information to a network device, where the capability information indicates whether the terminal is capable of buffering data in advance.

According to a second aspect of the embodiments of the present disclosure, a capability determination method is provided. The method is performed by a network device and includes: receiving capability information sent by a terminal; and determining, according to the capability information, whether the terminal is capable of buffering data in advance.

According to a third aspect of the embodiments of the present disclosure, a communication apparatus is provided. The communication apparatus includes: a processor; and a memory, to storing a computer program, where when the computer program is executed by the processor, the capability reporting method is implemented.

According to a fourth aspect of the embodiments of the present disclosure, a communication apparatus is provided. The communication apparatus includes: a processor; and a memory, to storing a computer program, where when the computer program is executed by the processor, the capability determination method is implemented.

According to a fifth aspect of the embodiments of the present disclosure, a computer-readable storage medium is provided. The computer-readable storage medium is configured to store a computer program; where when the computer program is executed by a processor, steps of the capability reporting method are implemented.

According to a sixth aspect of the embodiments of the present disclosure, a computer-readable storage medium is provided. The computer-readable storage medium is configured to store a computer program; where when the computer program is executed by a processor, steps of the capability determination method are implemented.

### BRIEF DESCRIPTION OF DRAWINGS

To more clearly describe technical solutions in embodiments of the present disclosure, accompanying drawings that need to be used in the description of the embodiments will be briefly described below. The accompanying drawings described below are merely some of the embodiments of the present disclosure, and those skilled in the art may also obtain other drawings based on these accompanying drawings without creative efforts.

FIG. 1 is a schematic flowchart of a capability reporting method shown according to an embodiment of the present disclosure.

FIG. 2 is a schematic flowchart of another capability reporting method shown according to an embodiment of the present disclosure.

FIG. 3 is a schematic flowchart of a capability determination method shown according to an embodiment of the present disclosure.

FIG. 4 is a schematic flowchart of another capability determination method shown according to an embodiment of the present disclosure.

FIG. 5 is a schematic block diagram of a capability reporting apparatus shown according to an embodiment of the present disclosure.

FIG. 6 is a schematic block diagram of a capability determination apparatus shown according to an embodiment of the present disclosure.

FIG. 7 is a schematic block diagram of a capability reporting apparatus shown according to an embodiment of the present disclosure.

FIG. 8 is a schematic block diagram of a capability determination apparatus shown according to an embodiment of the present disclosure.

### DETAILED DESCRIPTION

The technical solutions in the embodiments of the present disclosure will be described clearly and completely below in combination with the accompanying drawings in the embodiments of the present disclosure. The described embodiments are merely a part of and not all of the embodiments of the present disclosure. All other embodiments obtained by those skilled in the art based on the embodiments of the present disclosure without creative efforts shall fall within the scope of protection of the present disclosure.

Terms used in the embodiments of the present disclosure are only for a purpose of describing specific embodiments, and are not intended to limit the embodiments of the present disclosure. Singular forms, “a/an” and “the” used in the embodiments and the appended claims of the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish a same type of information from each other. For example, without departing from the scope of the embodiments of the present disclosure, a first position may also be referred to as a second position, and similarly, the second position may also be referred to as the first position. Depending on the context, the term “if” used herein may be interpreted as “when,” “while,” or “in response to determining.”

For purposes of brevity and ease of understanding, the used term is “greater than,” “less than,” “higher than,” or “lower than” when representing a size relationship herein. However, those skilled in the art may understand that the term “greater than” also covers the meaning of “greater than or equal to,” the term “less than” also covers the meaning of “less than or equal to,” the term “higher than” covers the meaning of “higher than or equal to,” and the term “lower than” also covers the meaning of “lower than or equal to.”

FIG. 1 is a schematic flowchart of a capability reporting method shown according to an embodiment of the present disclosure. The capability reporting method shown in this embodiment may be performed by a terminal, and the terminal includes but is not limited to a communication apparatus, such as a mobile phone, a tablet computer, a wearable device, a sensor, an Internet of Things device, etc. The terminal may communicate with a network device, and the network device includes but is not limited to a network device, such as a base station, a core network, etc., in a communication system, such as 4G, 5G, 6G, etc.

As shown in FIG. 1, the capability reporting method may include the following step S101.

At step S101, capability information is sent to a network device. For example, the capability information may be carried in RRC (radio resource control) signaling and sent to the network device. The capability information indicates whether the terminal is capable of buffering data in advance.

In an embodiment, the data includes data to be used by the terminal in a region where communication is affected.

In an embodiment, the terminal may pass through a region where communication is affected during movement. For example, when the terminal moves on a highway, for example, a user holding a mobile phone drives a car to travel on the highway, that is, the mobile phone moves in a public cell, and may pass through a region where communication is affected, where the region includes a tunnel passed through by the highway. For example, when the terminal moves in a high-speed-railway dedicated network, the terminal may pass through a region where communication is affected, where the region includes a tunnel passed through by a high-speed-train. The following embodiments mainly illustrate technical solutions of the present disclosure in a scenario in which a terminal moves in a high-speed-railway dedicated network.

In an embodiment, the network device includes a network device in a high-speed-railway dedicated network, and/or the region includes a tunnel.

Because the communication performed by the terminal in the region may be affected, for example, in the case where the region includes a tunnel, after a user riding a high-speed-train carries the terminal to enter the tunnel, the communication quality of the terminal may be reduced, or even a communication interruption may occur, which causes a service performed by the terminal to be affected.

For example, before entering the tunnel, the user is watching an online video with the terminal, and after entering the tunnel, because the communication quality is reduced, a data transmission rate of a video service is reduced or even interrupted, such that playing of the video watched by the user is blocked or even stopped, and user experience is seriously affected.

For this issue, before entering the region where the communication is affected, the terminal may send request information to the network device, to request the network device to send data to be used by the terminal in the region to the terminal, so that the terminal may buffer in advance the data sent by the network device for subsequent use after entering the region, which ensures continuity of the service performed by the terminal before entering the region and after entering the region.

Because the terminal is to occupy an uplink resource to send the request information to the network device, the network device is to configure the uplink resource for sending the request information for the terminal. However, not all terminals are capable of buffering data in advance. Even though the network device configures the uplink resource to send the request information to a terminal that is not capable of buffering the data in advance, the terminal will not send request information through the configured uplink resource, thereby wasting a communication resource.

According to the embodiment of the present disclosure, the terminal may send the capability information to the network device, so that the network device may determine whether the terminal is capable of buffering the data in advance according to the capability information; and then only in a case of determining that the terminal is capable of buffering the data in advance, the network device configures the uplink resource for sending the request information for the terminal, while in a case of determining that the terminal is not capable of buffering the data in advance, the terminal also does not send the request information to the network device, so that the network device does not need to configure the uplink resource for sending the request information for the terminal, which is beneficial for avoiding resource waste.

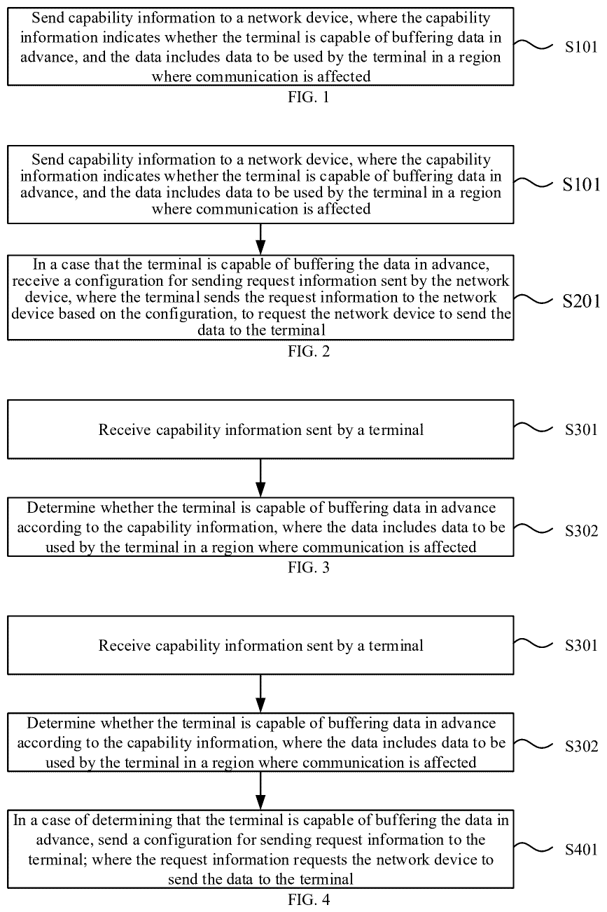

FIG. 2 is a schematic flowchart of another capability reporting method shown according to an embodiment of the present disclosure. As shown in FIG. 2, the method further includes step S201.

At step S201, in a case that the terminal is capable of buffering the data in advance, a configuration for sending request information sent by the network device is received; for example, the network device may add the configuration into the RRC signaling and send the RRC signaling to the terminal. The terminal sends the request information to the network device based on the configuration, to request the network device to send the data to the terminal.

In an embodiment, after the terminal sends the capability information to the network device, and in the case of determining that the terminal is capable of buffering the data in advance according to the capability information, the network device may send a configuration to the terminal, and the terminal may receive the configuration and then send request information to the network device according to the configuration. For example, the configuration may include an uplink resource to be used to send the request information, and the terminal may send the request information with the uplink resource.

It should be noted that the configuration sent by the network device to the terminal may further carry other information, which is not limited to the above uplink resource, and in some cases, even though the network device sends the configuration to the terminal, the terminal may not necessarily send the request information. For example, the network device indicates, through the configuration, that the terminal is not allowed to send the request information. The specific conditions are described in subsequent embodiments.

In an embodiment, the request information further carries at least one of the following auxiliary information: a data volume of the data; a time for sending the data; or a duration for sending the data.

The request information sent by the terminal to the network device may further carry the auxiliary information for reference by the network device. It should be noted that the auxiliary information is only for reference by the network device, and cannot determine an action of the network device, that is, the network device may select to send the data requested by the terminal according to the auxiliary information, or may select to not send the data requested by the terminal according to the auxiliary information, but send the data to the terminal according to a configuration of the network device, a protocol agreement, etc.

For example, the request information may further carry a data volume of the data which the terminal requests the network device to send in advance, and the network device may send the data of the data volume to the terminal accordingly. Of course, the network device may also determine the data volume of data to be sent as needed.

For example, the request information may further carry a time at which the terminal requests the network device to send the data in advance, and the network device may send the data to the terminal at the time accordingly. Of course, the network device may also determine the time for sending the data as needed.

For example, the request information may further carry a duration at which the terminal requests the network device to send the data in advance, and the network device may send the data of the data volume to the terminal accordingly. Of course, the network device may also determine the data volume of data to be sent as needed.

In an embodiment, the configuration further indicates at least one of: whether the terminal is allowed to send the request information; information of a blocking timer for blocking the terminal from sending the request information; or one or more conditions for sending the request information.

The configuration sent by the network device to the terminal may further indicate whether the terminal is allowed to send the request information. For example, the configuration carries indication information that indicates whether the terminal is allowed to send the request information. The terminal sends the request information according to the uplink resource in the configuration only in the case of determining that the request information is allowed to be sent, and does not send the request information according to the uplink resource in the configuration in the case of determining that the request information is not allowed to be sent.

The configuration sent by the network device to the terminal may further include information of a blocking timer, for example, a duration of the blocking timer. The terminal may not send the request information to the network device before the blocking timer expires. For example, the terminal may start or restart the blocking timer when sending the request information once, may not send the request information again before the blocking timer expires, and may send the request information again after the blocking timer expires.

The configuration sent by the network device to the terminal may further indicate one or more conditions for the terminal to send the request information to the network device, and the terminal may send the request information to the network device only in the case of determining that the one or more conditions are met, which is beneficial to ensure that the network device flexibly controls the action of the terminal reporting the request information.

The one or more conditions are exemplarily described below through several embodiments.

In an embodiment, the one or more conditions include at least one of: a location condition, indicating that the terminal, before entering the region, sends the request information at a location from the region by a preset distance; a signal condition, indicating that the terminal, before entering the region, sends the request information when a signal strength of the network device is lower than a preset strength threshold; or a speed condition, indicating that the terminal, before entering the region, sends the request information when a speed of the terminal is lower than a speed threshold.

Because the region may be fixed, an entering location (for example, an entry of a tunnel in a high-speed-railway dedicated network) of the region is also fixed. Therefore, the terminal may determine a location that is from the entering location by a preset distance before entering the region, determine that the location condition is met when moving to the determined location, and then send the request information to the network device.

The terminal may detect a signal strength of the network during movement, and before entering the region, when determining that the signal strength is lower than a strength threshold (for example, when the terminal is near the entry of the tunnel, a signal coverage situation is poor due to occlusion of a mountain), the terminal may determine that the signal condition is met, and then send the request information to the network device.

The terminal may detect a moving speed of the terminal during movement, and before entering the region and when determining that the moving speed is lower than a speed threshold (for example, the high-speed-train is to slow down appropriately before entering the tunnel), the terminal may determine that the signal condition is met, and then send the request information to the network device.

FIG. 3 is a schematic flowchart of a capability determination method shown according to an embodiment of the present disclosure. The capability determination method shown in this embodiment may be performed by a network device, which may communicate with a terminal. The terminal includes but is not limited to a communication apparatus, such as a mobile phone, a tablet computer, a wearable device, a sensor, and an Internet of Things device, etc. The network device includes but is not limited to a network device, for example, a base station, a core network, etc., in a communication system, such as 4G, 5G, 6G, etc.

As shown in FIG. 3, the capability determination method may include the following steps S301-S302.

At step S301, capability information sent by a terminal is received.

At step S302, whether the terminal is capable of buffering data in advance is determined according to the capability information.

In an embodiment, the data includes data to be used by the terminal in a region where communication is affected.

In an embodiment, the terminal may pass through a region where communication is affected during movement. For example, when the terminal moves on a highway, for example, a user holding a mobile phone drives a car to travel on the highway, that is, the mobile phone moves in a public cell, and may pass through a region where communication is affected, where the region includes a tunnel passed through by the highway. For example, when the terminal moves in a high-speed-railway dedicated network, the terminal may pass through a region where communication is affected, where the region includes a tunnel passed through by a high-speed-train. The following embodiments mainly illustrate technical solutions of the present disclosure in a scenario in which a terminal moves in a high-speed-railway dedicated network.

In an embodiment, the network device includes a network device in a high-speed-railway dedicated network, and/or the region includes a tunnel.

Because the communication performed by the terminal in the region may be affected, for example, in the case where the region includes a tunnel, after a user riding a high-speed-train carries the terminal to enter the tunnel, the communication quality of the terminal may be reduced, or even a communication interruption may occur, which causes a service performed by the terminal to be affected.

For example, before entering the tunnel, the user is watching an online video with the terminal, and after entering the tunnel, because the communication quality is reduced, a data transmission rate of a video service is reduced or even interrupted, such that playing of the video watched by the user is blocked or even stopped, and user experience is seriously affected.

For this issue, before entering the region where the communication is affected, the terminal may send request information to the network device, to request the network device to send data to be used by the terminal in the region to the terminal, so that the terminal may buffer in advance the data sent by the network device for subsequent use after entering the region, which ensures continuity of the service performed by the terminal before entering the region and after entering the region.

Because the terminal is to occupy an uplink resource to send the request information to the network device, the network device is to configure the uplink resource for sending the request information for the terminal. However, not all terminals are capable of buffering data in advance. Even though the network device configures the uplink resource to send the request information to a terminal that is not capable of buffering the data in advance, the terminal will not send request information through the configured uplink resource, thereby wasting a communication resource.

According to the embodiment of the present disclosure, the network device may receive the capability information sent by the terminal, and then may determine whether the terminal is capable of buffering the data in advance according to the capability information; and only in a case of determining that the terminal is capable of buffering the data in advance, the network device configures the uplink resource for sending the request information for the terminal, while in a case of determining that the terminal is not capable of buffering the data in advance, the terminal also does not send the request information to the network device, so that the network device does not need to configure the uplink resource for sending the request information for the terminal, which is beneficial for avoiding resource waste.

FIG. 4 is a schematic flowchart of another capability determination method shown according to an embodiment of the present disclosure. As shown in FIG. 4, the method further includes step S401.

At step S401, in a case of determining that the terminal is capable of buffering the data in advance, a configuration for sending request information is sent to the terminal; where the request information requests the network device to send the data to the terminal.

In an embodiment, in the case that the network device determines that the terminal is capable of buffering the data in advance according to the capability information sent by the terminal, the network device may send a configuration to the terminal, and the terminal may receive the configuration and then send request information to the network device according to the configuration. For example, the configuration may include an uplink resource to be used to send the request information, and the terminal may send the request information with the uplink resource.

In an embodiment, the configuration further indicates at least one of: whether the terminal is allowed to send the request information; information of a blocking timer for blocking the terminal from sending the request information; or one or more conditions for sending the request information.

The configuration sent by the network device to the terminal may further indicate whether the terminal is allowed to send the request information. For example, the configuration carries indication information that indicates whether the terminal is allowed to send the request information. The terminal sends the request information according to the uplink resource in the configuration only in the case of determining that the request information is allowed to be sent, and does not send the request information according to the uplink resource in the configuration in the case of determining that the request information is not allowed to be sent.

The configuration sent by the network device to the terminal may further include information of a blocking timer, for example, a duration of the blocking timer. The terminal may not send the request information to the network device before the blocking timer expires. For example, the terminal may start or restart the blocking timer when sending the request information once, may not send the request information again before the blocking timer expires, and may send the request information again after the blocking timer expires.

The configuration sent by the network device to the terminal may further indicate one or more conditions for the terminal to send the request information to the network device, and the terminal may send the request information to the network device only in the case of determining that the one or more conditions are met, which is beneficial to ensure that the network device flexibly controls the action of the terminal reporting the request information.

The one or more conditions are exemplarily described below through several embodiments.

In an embodiment, the one or more conditions include at least one of: a location condition, indicating that the terminal, before entering the region, sends the request information at a location from the region by a preset distance; a signal condition, indicating that the terminal, before entering the region, sends the request information when a signal strength of the network device is lower than a preset strength threshold; or a speed condition, indicating that the terminal, before entering the region, sends the request information when a speed of the terminal is lower than a speed threshold.

Because the region may be fixed, an entering location (for example, an entry of a tunnel in a high-speed-railway dedicated network) of the region is also fixed. Therefore, the terminal may determine a location that is from the entering location by a preset distance before entering the region, determine that the location condition is met when moving to the determined location, and then send the request information to the network device.

The terminal may detect a signal strength of the network during movement, and before entering the region, when determining that the signal strength is lower than a strength threshold (for example, when the terminal is near the entry of the tunnel, a signal coverage situation is poor due to occlusion of a mountain), the terminal may determine that the signal condition is met, and then send the request information to the network device.

The terminal may detect a moving speed of the terminal during movement, and before entering the region and when determining that the moving speed is lower than a speed threshold (for example, the high-speed-train is to slow down appropriately before entering the tunnel), the terminal may determine that the signal condition is met, and then send the request information to the network device.

Corresponding to the above embodiments of the capability reporting method and the capability determination method, the present disclosure further provides embodiments of a capability reporting apparatus and a capability determination apparatus.

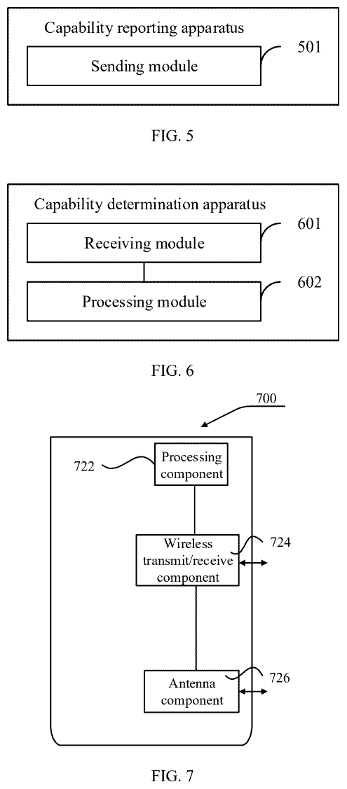

FIG. 5 is a schematic block diagram of a capability reporting apparatus shown according to an embodiment of the present disclosure. The capability reporting apparatus shown in this embodiment may a terminal, or an apparatus formed by modules in a terminal. The terminal includes but is not limited to a communication apparatus, such as a mobile phone, a tablet computer, a wearable device, a sensor, an Internet of Things device, etc. The terminal may communicate with a network device, and the network device includes but is not limited to a network device, such as a base station, a core network, etc., in a communication system, such as 4G, 5G, 6G, etc. As shown in FIG. 5, the capability reporting apparatus may include:

a sending module 501, configured to send capability information to a network device, where the capability information indicates whether a terminal is capable of buffering data in advance.

In an embodiment, the data includes data to be used by the terminal in a region where communication is affected.

In an embodiment, the terminal is in a high-speed-railway dedicated network, and/or the region includes a tunnel.

In an embodiment, the apparatus further includes: a receiving module, configured to receive, in a case that the terminal is capable of buffering the data in advance, a configuration for sending request information sent by the network device, where the request information requests the network device to send the data to the terminal.

In an embodiment, the request information further carries at least one of following auxiliary information: a data volume of the data, a time for sending the data, or a duration for sending the data.

In an embodiment, the configuration further indicates at least one of: whether the terminal is allowed to send the request information; information of a blocking timer for blocking the terminal from sending the request information; or one or more conditions for sending the request information.

In an embodiment, the one or more conditions include at least one of: a location condition, indicating that the terminal, before entering the region, sends the request information at a location from the region by a preset distance; a signal condition, indicating that the terminal, before entering the region, sends the request information when a signal strength of the network device is lower than a preset strength threshold; or a speed condition, indicating that the terminal, before entering the region, sends the request information when a speed of the terminal is lower than a speed threshold.

FIG. 6 is a schematic block diagram of a capability determination apparatus shown according to an embodiment of the present disclosure. The capability determination apparatus shown in this embodiment may be a network device or an apparatus formed by modules in a network device. The network device may communicate with a terminal. The terminal includes but is not limited to a communication apparatus, such as a mobile phone, a tablet computer, a wearable device, a sensor, and an Internet of Things device, etc. The network device includes but is not limited to a network device, for example, a base station, a core network, etc., in a communication system, such as 4G, 5G, 6G, etc.

As shown in FIG. 6, the capability determination apparatus may include:
a receiving module 601, configured to receive capability information sent by a terminal; and
a processing module 602, configured to determine, according to the capability information, whether the terminal is capable of buffering data in advance.

In an embodiment, the data includes data to be used by the terminal in a region where communication is affected.

In an embodiment, the terminal is in a high-speed-railway dedicated network, and/or the region includes a tunnel.

In an embodiment, the apparatus further includes: a sending module, configured to send, in a case of determining that the terminal is capable of buffering the data in advance, a configuration for sending request information to the terminal; where the request information requests the network device to send the data to the terminal.

In an embodiment, the configuration further indicates at least one of: whether the terminal is allowed to send the request information; information of a blocking timer for blocking the terminal from sending the request information; or one or more conditions for sending the request information.

In an embodiment, the one or more conditions include at least one of: a location condition, indicating that the terminal, before entering the region, sends the request information at a location from the region by a preset distance; a signal condition, indicating that the terminal, before entering the region, sends the request information when a signal strength of the network device is lower than a preset strength threshold; or a speed condition, indicating that the terminal, before entering the region, sends the request information when a speed of the terminal is lower than a speed threshold.

The specific manners in which each of the modules of the apparatus in the above embodiments performs operations have been described in detail in the embodiments related to the methods, and will not be explained here in detail.

Since the embodiments of the apparatuses substantially correspond to the embodiments of the methods, and the related contents may refer to the description of the embodiments of the methods. The embodiments of the apparatus described above are only schematic. The modules explained as separate components may be or may not be physically separated, and the components displayed as modules may be or may not be physical modules, that is, they may be located in one place or may be distributed across multiple network modules. A part or all of modules may be selected according to actual needs to achieve the purpose of the solutions in these embodiments. Those skilled in the art may understand and implement other embodiments without creative efforts.

An embodiment of the present disclosure further provides a communication apparatus, including: a processor; and a memory, to storing a computer program, where when the computer program is executed by the processor, the capability reporting method of any one of the above embodiments is implemented.

An embodiment of the present disclosure further provides a communication apparatus, including: a processor; and a memory, to storing a computer program, where when the computer program is executed by the processor, the capability determination method of any one of the above embodiments is implemented.

An embodiment of the present disclosure further provides a computer-readable storage medium, configured to store a computer program; where when the computer program is executed by the processor, steps of the capability reporting method of any one of the above embodiments are implemented.

An embodiment of the present disclosure further provides a computer-readable storage medium, configured to store a computer program; where when the computer program is executed by the processor, steps of the capability determination method of any one of the above embodiments are implemented.

As shown in FIG. 7, FIG. 7 is a schematic block diagram of a capability determination apparatus 700 shown according to an embodiment of the present disclosure. The apparatus 700 may be provided as a base station. Referring to FIG. 7, the apparatus 700 includes a processing component 722, a wireless transmit/receive component 724, an antenna component 726, and a signal processing part specific to a wireless interface. The processing component 722 may further include one or more processors. One processor of the processing component 722 may be configured to implement the capability determination method of any one of the above embodiments.

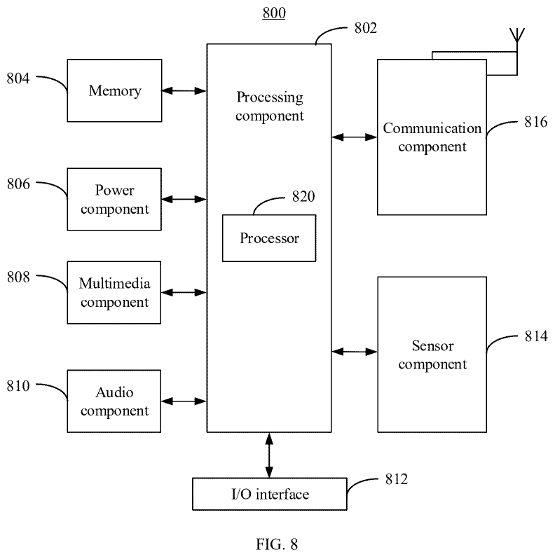

FIG. 8 is a schematic block diagram of a capability reporting apparatus 800 shown according to an embodiment of the present disclosure. For example, the apparatus 800 may be a mobile phone, a computer, a digital broadcast terminal, a message transceiving device, a game console, a tablet device, a medical device, a fitness device, a personal digital assistant, etc.

Referring to FIG. 8, the apparatus 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the apparatus 800, such as operations associated with display, phone calls, data communication, camera operations, and recording operations. The processing component 802 may include one or more processors 820 to execute instructions to complete all or part of the steps in the above capability reporting method. Additionally, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations of the apparatus 800. Examples of such data include instructions, contact data, phonebook data, messages, pictures, videos, etc., for any application program or method operating on the apparatus 800. The memory 804 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides power to various components of the apparatus 800. The power component 806 may include a power supply management system, one or more power supplies, and other components that are associated with generating, managing, and distributing power for the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen, to receive an input signal from the user. The touch panel includes one or more touch sensors to sense the touch, the slide, and the gesture on the touch panel. The touch sensor may not only sense a boundary of the touch or slide action, but also detect a duration and pressure related to the touch or slide operation. In some embodiments, the multimedia component 808 includes a front facing camera and/or a rear facing camera. When the apparatus 800 is in an operation mode, such as a shooting mode or a video mode, the front facing camera and/or the rear facing camera may receive external multimedia data. Each of the front facing camera and rear facing camera may be a fixed optical lens system or has a focal length and an optical zoom capability.

The audio component 810 is configured to output and/or input audio signals. For example, the audio component 810 includes a microphone (MIC). The microphone is configured to receive external audio signals when the apparatus 800 is in the operating mode, such as a call mode, a recording mode, and a speech recognition mode. The received audio signals may be further stored in the memory 804 or sent via the communication component 816. In some embodiments, the audio component 810 also includes a speaker to output the audio signals.

The I/O interface 812 provides an interface between the processing component 802 and peripheral interface modules. The peripheral interface modules may be keyboards, click wheels, buttons, etc. These buttons may include but are not limited to: a home button, a volume button, a start button, and a lock button.

The sensor component 814 includes one or more sensors to provide various aspects of state assessment for the apparatus 800. For example, the sensor component 814 may detect an open/closed state of the apparatus 800, relative positioning of components that are for example a display and keypad of the apparatus 800. The sensor component 814 may also detect a position change of the apparatus 800 or of a component of the apparatus 800, presence or absence of the user contacting with the apparatus 800, an orientation or acceleration/deceleration of the apparatus 800, and a temperature change of the apparatus 800. The sensor component 814 may include a proximity sensor configured to detect the presence of nearby objects without any physical contact. The sensor component 814 may also include a light sensor, such as a CMOS or CCD image sensor, for use in an imaging application. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the apparatus 800 and other devices. The apparatus 800 may access a wireless network based on a communication standard, such as WiFi, 2G, 3G, 4G LTE, 5G NR, or a combination of them. In an exemplary embodiment, the communication component 816 receives, via a broadcast channel, a broadcast signal or broadcast related information from an external broadcast management system. In an exemplary embodiment, the communication component 816 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above capability reporting method.

In an exemplary embodiment, a non-transitory computer-readable storage medium including instructions is also provided, such as the memory 804 including the instructions. The above instructions may be executed by the processor 820 of the apparatus 800 to complete the above capability reporting method. For example, the non-transitory computer-readable storage medium may be an ROM, a random access memory (RAM), a CD-ROM, a magnetic tape, a floppy disk, an optical data storage device, etc.

Those skilled in the art will easily come up with other implementation solutions of the present disclosure after considering the specification and practicing the present disclosure disclosed herein. The present disclosure aims to cover any variations, uses, or adaptive changes of the present disclosure, which follow general principles of the present disclosure and include common knowledge or customary technical means in the art not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes may be made without departing from its scope. The scope of the present disclosure is limited only by the appended claims.

It should be noted that the relationship terms used herein, such as “first,” “second” and the like are only to distinguish one entity or operation from another entity or operation, but do not necessarily require or imply that there is any actual relationship or order between these entities or operations. The terms “include,” “comprise,” or any variants thereof are intended to cover a non-exclusive inclusion, such that processes, methods, articles, or devices, including a series of elements, include not only those elements that have been listed, but also other elements that are not specifically listed or the elements intrinsic to these processes, methods, articles, or devices. Without further limitations, elements limited by the wording “include(s) a/an . . .” or “comprise(s) a/an . . .” do not exclude additional identical elements in the processes, methods, articles or devices, including the listed elements.

The methods and apparatuses provided by the embodiments of the present disclosure are described in detail above, specific examples are applied herein to describe the principles and implementations of the present disclosure, and the description of the above embodiments is only used to help understand the methods of the present disclosure and the core idea thereof; meanwhile, for those skilled in the art, according to the idea of the present disclosure, there will be changes in the specific implementations and application scope. In summary, the content of the present disclosure should not be construed as limiting the present disclosure.

According to a seventh aspect of the embodiments of the present disclosure, a capability reporting apparatus is provided. The apparatus includes: a sending module, configured to send capability information to a network device, where the capability information indicates whether a terminal is capable of buffering data in advance.

According to an eighth aspect of the embodiments of the present disclosure, a capability determination apparatus is provided. The apparatus includes: a receiving module, configured to receive capability information sent by a terminal; and a processing module, configured to determine, according to the capability information, whether the terminal is capable of buffering data in advance.

1. A method for capability reporting performed by a terminal, the method comprising:
sending capability information to a network device, wherein the capability information indicates whether the terminal is capable of buffering data in advance.

2. The method of claim 1, wherein the data comprises data to be used by the terminal in a region where communication is affected.

3. The method of claim 2, wherein
the terminal is in a high-speed-railway dedicated network; and/or
the region comprises a tunnel.

4. The method of claim 2, further comprising:
receiving, in a case that the terminal is capable of buffering the data in advance, a configuration sent by the network device for the terminal sending request information, wherein the terminal sends the request information to the network device based on the configuration, to request the network device to send the data to the terminal.

5. The method of claim 4, wherein the request information further carries at least one of following auxiliary information:
a data volume of the data;
a time for sending the data; or
a duration for sending the data.

6. The method of claim 4, wherein the configuration further indicates at least one of:
whether the terminal is allowed to send the request information;
information of a blocking timer for blocking the terminal from sending the request information; or
one or more conditions for sending the request information.

7. The method of claim 6, wherein the one or more conditions comprise at least one of:
a location condition, indicating that the terminal, before entering the region, sends the request information at a location from the region by a preset distance;
a signal condition, indicating that the terminal, before entering the region, sends the request information when a signal strength of the network device is lower than a preset strength threshold; or
a speed condition, indicating that the terminal, before entering the region, sends the request information when a speed of the terminal is lower than a speed threshold.

8. A method for capability determination performed by a network device, the method comprising:
receiving capability information sent by a terminal; and
determining, according to the capability information, whether the terminal is capable of buffering data in advance.

9. The method of claim 8, wherein the data comprises data to be used by the terminal in a region where communication is affected.

10. The method of claim 9, wherein
the terminal is in a high-speed-railway dedicated network; and/or
the region comprises a tunnel.

11. The method of claim 9, further comprising:
sending, in a case of determining that the terminal is capable of buffering the data in advance, a configuration for sending request information to the terminal, wherein the request information requests the network device to send the data to the terminal.

12. The method of claim 11, wherein the configuration further indicates at least one of:
whether the terminal is allowed to send the request information;
information of a blocking timer for blocking the terminal from sending the request information; or
one or more conditions for sending the request information.

13. The method of claim 12, wherein the one or more conditions comprise at least one of:
a location condition, indicating that the terminal, before entering the region, sends the request information at a location from the region by a preset distance;
a signal condition, indicating that the terminal, before entering the region, sends the request information when a signal strength of the network device is lower than a preset strength threshold; or a speed condition, indicating that the terminal, before entering the region, sends the request information when a speed of the terminal is lower than a speed threshold.

14. (canceled)

15. (canceled)

16. A communication apparatus, comprising:
a processor; and
a memory, to storing a computer program;
wherein the processor executes the computer program to:
send capability information to a network device, wherein the capability information indicates whether the communication apparatus is capable of buffering data in advance.

17. A communication apparatus, comprising:
a processor; and
a memory, to storing a computer program;
wherein the computer program when executed by the processor causes the communication apparatus to act as the network device and perform the method of claim 8.

18. A non-transitory computer-readable storage medium storing a computer program, the computer program when executed by a processor of the terminal causes the terminal to perform method of claim 1.

19. A non-transitory computer-readable storage medium storing a computer program, the computer program when executed by a processor of the network device cause the network device to perform the method of claim 8.

20. The method of claim 5, wherein the configuration further indicates at least one of:
whether the terminal is allowed to send the request information;
information of a blocking timer for blocking the terminal from sending the request information; or
one or more conditions for sending the request information.

21. The communication apparatus of claim 16, wherein the data comprises data to be used by a terminal in a region where communication is affected.

22. The communication apparatus of claim 21, wherein
the terminal is in a high-speed-railway dedicated network; and/or
the region comprises a tunnel.
